(19) United States
(12) Patent Application Publication
(10) Pub. No.: US 2025/0294077 A1
(43) Pub. Date: Sep. 18, 2025

(54) AREA PROFILES FOR DEVICES

(71) Applicant: Hewlett-Packard Development Company, L.P., Spring, TX (US)

(72) Inventors: Andre da Fonte Lopes da Silva, Palo Alto, CA (US); Carol Ozaki, Palo Alto, CA (US)

(73) Assignee: Hewlett-Packard Development Company, L.P., Spring, TX (US)

(21) Appl. No.: 18/702,613

(22) PCT Filed: Jan. 24, 2022
(86) PCT No.: PCT/US2022/013475

§ 371 Date: Apr. 18, 2024

(51) Int. Cl. H04L 67/30; H04L 65/403; H04L 67/52; H04L 67/54; H04W 4/021

(52) U.S. Cl. CPC H04L 67/30; H04L 65/403; H04L 67/52; H04L 67/54; H04W 4/021

(57) ABSTRACT

In some examples, the disclosure describes a device that includes a communication device, and a processor to: identify a plurality of devices within an area, collect video data and audio data from the plurality of devices within the area utilizing the communication device, generate an area profile for the area utilizing the video data and audio data from the plurality of devices, and provide the area profile to a communication application utilizing the communication device.

### BACKGROUND

Computing devices are utilized to perform particular functions. In some examples, computing devices utilize battery power that is limited when the computing device is not connected to an electrical power source. In some examples, computing devices are mobile computing devices that are carriable or moveable from a first location to a second location. In some examples, a mobile computing device is positioned on a human user and the human user may be negatively affected by wireless transmissions during use.

### BRIEF DESCRIPTION OF THE DRAWINGS

FIG. 1 illustrates an example of a system for area profiles for devices.

FIG. 2 illustrates an example of a system for area profiles for devices.

FIG. 3 illustrates an example of a display for area profiles for devices.

FIG. 4 illustrates an example of a device for area profiles for devices.

FIG. 5 illustrates an example of a memory resource for area profiles for devices.

FIG. 6 illustrates an example of a system for area profiles for devices.

### DETAILED DESCRIPTION

A user may utilize a computing device for various purposes, such as for business and/or recreational use. As used herein, the term computing device refers to an electronic device having a processor and a memory resource. Examples of computing devices include, for instance, a laptop computer, a notebook computer, a desktop computer, an all-in-one (AIO) computing device, and/or a mobile device (e.g., a smart phone, tablet, personal digital assistant, smart glasses, a wrist-worn device, etc.), among other types of computing devices.

In some examples, the computing device is a mobile computing device that is portable to a plurality of different locations. For example, a user may bring the computing device into a plurality of different workspaces, conference rooms, and/or offices within a building. In some examples, the portable computing devices include hardware that can collect audio, video, and/or other data. For example, the computing devices can include still image cameras, video cameras, microphones, infrared cameras, biometric sensors, and/or other hardware that can be coupled to the computing devices.

In some examples, the computing devices are used with applications to communicate with remote devices. For example, computing devices are utilized with conferencing applications to share audio data, visual data, and/or other data with remote computing devices. In some examples, a plurality of users may utilize a corresponding plurality of computing devices within a similar area. In these examples, the plurality of users may form a group within the similar area to communicate as a group with a plurality of remote devices. In these examples, each user may separately interact with a conferencing application to generate individual profiles for each of the plurality of users. In this example, the plurality of computing devices provide data (e.g., audio data, video data, etc.) to a corresponding profile. However, the group includes a plurality of profiles that separate and/or distinct.

The present disclosure relates to generating area profiles for devices. The area profiles can be utilized for conferencing sessions with remote devices. In this way, a plurality of users that utilize separate computing devices are able to utilize a single profile for the shared area. For example, a conference room can be utilized by a plurality of users that bring a plurality of portable computing devices. In this example, a single area profile is generated with the conferencing application and audio data and video data can be collected from the plurality of computing devices to generate the single area profile for the plurality of users. In this way, the hardware from the plurality of computing devices is utilized to provide audio data and video data to the conferencing application associated with the area profile.

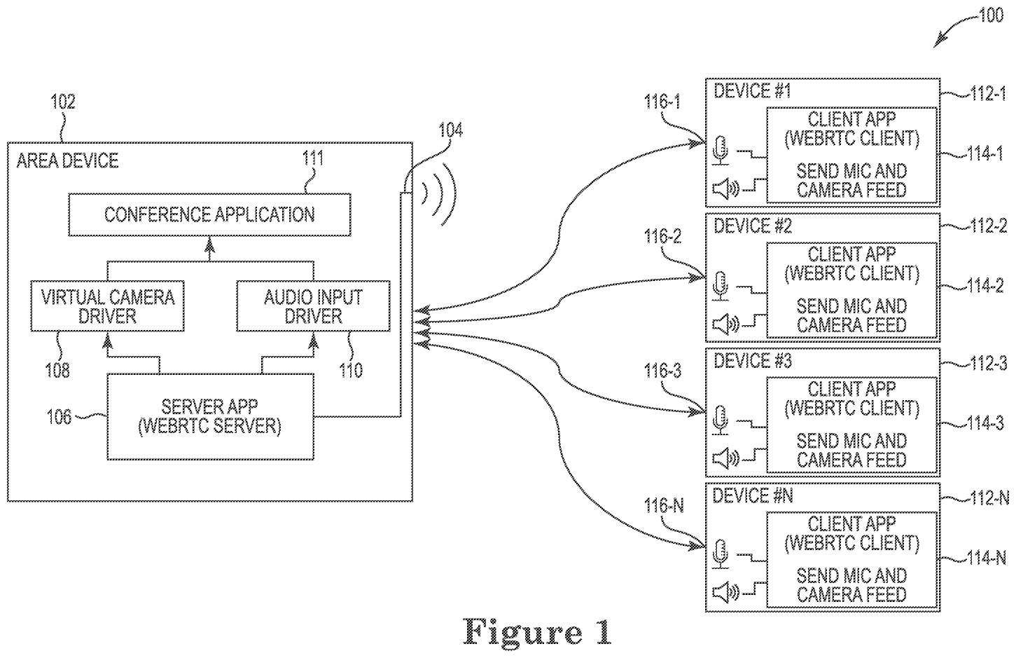

FIG. 1 illustrates an example of a system 100 for area profiles for devices. In some examples, the system 100 is positioned within a defined area. As used herein, a defined area includes a particular space with specified dimensions. For example, the defined area can be a room within a building. In some examples, the defined area is a conference room where a plurality of users meet to work on particular projects. In some examples, the defined area is defined by physical walls of the building.

In some examples, the defined area is defined by a distance from an area device 102. For example, the area device 102 includes a transmitter 104 that is capable of communicating with a plurality of computing devices 112-1, 112-2, 112-3, 112-N (collectively referred to as computing devices 112). In this example, the defined area is a limiting distance for the transmitter 104 to communicate with the computing devices 112. In other examples, the transmitter 104 is an ultrasonic wireless transmitter that does not transmit through building structures such as walls. In this way, the transmitter 104 would be limited to communicating with computing devices 112 within the defined area of a conference room or office of a building.

In some examples, the transmitter 104 is a communication interface or network interface. For example, the area device 102 can be communicatively coupled to the computing devices 112 through a local area network (LAN), wide area network (WAN), WIFI connection, and/or a wired connection to collect the video and audio data from the computing devices 112 within the area. Although specific network connections or computing connections are described herein, other types of connections can be utilized to transfer video and audio data between the area device 102 and the computing devices 112.

In some examples, the computing devices 112 are mobile computing devices that are moveable within the defined area and/or moveable out of the defined area. In this way, the quantity of computing devices 112 are able to change. For example, a plurality of users can utilize corresponding computing devices 112. In this example, a first quantity of users and corresponding computing devices 112 can be utilized during a first time period and a second quantity of users and corresponding computing devices can be utilized during a second time period. In this way, the quantity of computing devices 112 communicating with the area device 102 can change.

In some examples, the area device 102 is designated to a particular area. In some examples, the area device 102 identifies the computing devices 112 within the area and utilizes the transmitter 104 to send a message to a corresponding transmitter 116-1, 116-2, 116-3, 116-N (collectively referred to as transmitters 116) of the computing devices. In some examples, the message is an advertisement requesting access to collect data associated with the computing devices 112. That is, in some examples, the advertisement provides access to a camera and a microphone of the computing devices 112 to collect the video data and the audio data from the computing devices 112. For example, the computing device 112-1 can receive an advertisement message from the area device 102 when the computing device 112-1 enters the designated area assigned to the area device 102. In some examples, a user of the computing device 112-1 can utilize the advertisement message to grant access to the area device 102 to collect particular data from the computing device 112-1.

In some examples, the computing devices 112 include communication hardware such as, but not limited to: microphones, video cameras, still cameras, infrared cameras, speakers, among other types of devices used for communicating. In these examples, the communication hardware of the computing devices 112 can be utilized by the area device 102 individually or collectively. For example, the plurality of speakers can be utilized to generate sound received from a plurality of remote devices and/or from a conferencing application. In these examples, the plurality of speakers of the computing devices 112 can be provided with sound from the conferencing application individually or provided collectively to provide sound for the area.

In some examples, the area device 102 sends a request to the computing devices 112 when the computing devices 112 are within the defined area. In these examples, the request includes an advertisement to log on to the area profile for the defined area. In this way, the computing devices 112 are able to securely log in to the area profile of the designated area prior to the area device 102 allowing access to the area profile. In some examples, the area device 102 may log in to the communication application separately from the computing devices 112 logging on to the area profile.

In some examples, the area device 102 generates an area profile for the designated area that includes the computing devices 112. In these examples, the area device 102 can send the advertisement message to the computing devices 112 to join the area profile and provide data collected from hardware of the computing devices 112 for the area profile. For example, the area device 102 can receive access to collect video data from video cameras associated with the computing devices 112, collect still images from still image cameras associated with the computing devices 112, collect sound or audio data from microphones associated with the computing devices 112, and/or collect other data captured by hardware of the computing devices 112. In this way, the area device 102 can generate an output of audio data, video data, and/or other data for a single profile of the area with the computing devices 112 within the area at that time.

In some examples, the advertisement provided to the computing devices 112 includes a corresponding client application 114-1, 114-2, 114-3, 114-N (collectively referred to client applications 114) for the computing devices 112. For example, the advertisement message can initiate or download a corresponding client application 114 for the computing devices 112. In some examples, the client application 114 is utilized to provide the audio data, video data, or other data to the area device 102. In some examples, the client application 114 Web Real-Time Communication (WebRTC) client application for providing communication between devices utilizing application programming interfaces (APIs). Although a WebRTC client application and corresponding WebRTC server application for the area device 102 are illustrated, other examples of communication protocols can be utilized.

As described herein, the client applications 114 can provide video data and audio data to a server application 106 of the area device 102. The server application 106 can be the corresponding WebRTC server application for the client applications 114. In some examples, the server application 106 includes instructions to process the audio data and the video data received from the client applications 114 of the computing devices 112. In this way, data is simultaneously collected from the computing devices 112 within the designated area of the area device 102.

In some examples, the audio data is combined and/or the video data is combined to generate combined audio data and combined video data for the area profile generated by the area device 102. In some examples, the audio data is combined as a single audio file for the designated area as if the plurality of microphones associated with the computing devices 112 were an array of microphones. In these examples, a location of the computing devices 112 within the area is determined. For example, the location of the computing devices 112 can be determined based on a signal strength between the computing devices 112 and the area device 102. In other examples, the location of the computing devices can be determined based on a signal strength between the computing devices 112. In this way, a location of the computing devices 112 can be utilized to map the location of the corresponding microphones of the computing devices 112 and generate the audio file for the area profile based on the received audio data from the computing devices 112 and corresponding location of the computing devices 112 within the designated area.

In some examples, the video data is combined to generate a plurality of images within a profile area of the area profile. In some examples, each user of a communication application includes a designated area or space within a display area to display video or image data. In these examples, the video data from the computing devices 112 is positioned within the designated area of the area profile. However, in other examples, the video or image data captured by the cameras of the computing devices is utilized to generate a single image for the area profile. For example, the location of the computing devices 112 can be utilized to stitch images or video frames from the computing devices 112 into an area image. As used herein, stitching images includes connecting a first border of a first image with a second border of a second image. In this way, the area video can include a single image that is connected based on the location of the computing devices within the designated area.

In some examples, the area device 102 can generate a single image of the area utilizing the video data from the computing devices 112 within the area. In some examples, the panoramic image of the designated area is generated by stitching or connecting borders of the images or video generated by the computing devices. In this way, a panoramic image of the area and/or users of the computing devices 112 are generated and provided as the video or image data for the area profile. In some examples, the computing devices 112 are positioned at particular locations within the designated area to generate a 360-degree image of the designated area. For example, the computing devices 112 can be positioned around a table or area in a way that the cameras of the computing devices 112 are able to capture the borders or boundaries of the designated and the images or video captured by the computing devices 112 are stitched or connected to generate a 360-degree image. As used herein, a 360-degree image is a controllable panoramic image that surrounds a point. In some examples, the point can be a central or substantially center point of the designated area.

In some examples, the generated area audio and the generated area video is provided to corresponding virtual drivers that provide the area profile data to a conference application 111. As used herein, a conference application 111 is an application that allows a first computing device to transfer audio and/or video data to a second computing device in real time or substantially real time. In some examples, the area device 102 utilizes a virtual camera driver 108 to provide the generated area video data to the conference application 111. The virtual camera driver 108 is a driver that mimics a camera driver of a computing device (e.g., one of the computing devices 112). In a similar way, the area device 102 utilizes a virtual audio input driver 110 to provide the generated audio data to the conference application 111. The virtual audio input driver 110 is a driver that mimics an audio input driver of a computing device (e.g., one of the computing devices 112).

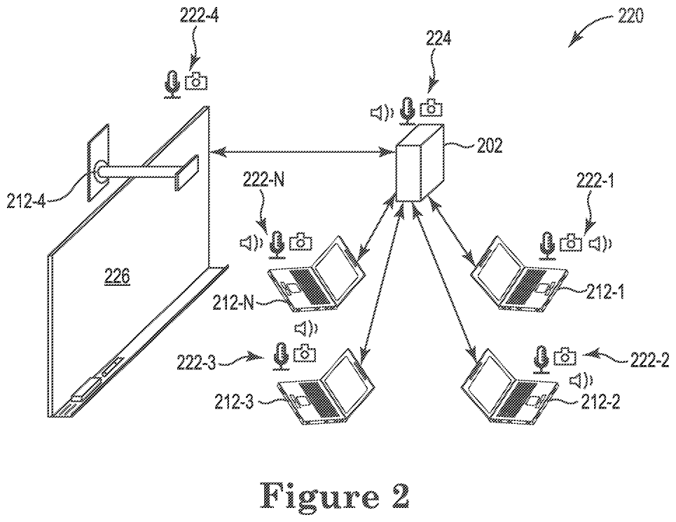

FIG. 2 illustrates an example of a system 200 for area profiles for devices. In some examples, the system 200 includes the same or similar elements as system 100 as referenced in FIG. 1. For example, the system 200 is positioned within a designated area. In some examples, the system 200 includes an area device 202. In some examples, the area device 202 includes a computing device designated for the designated area. For example, the area device 202 can include a server, cloud resource, or other computing resource that includes resources associated with the designated area.

In some examples, the area device 202 includes communication hardware 224 to be utilized for the designated area. In some examples, the communication hardware 224 includes microphones, cameras, speakers, communication drivers, virtual communication drivers, network connections, wireless transmitters, and/or other devices that are utilized to communicate with remote devices. In some examples, the area device 202 can utilize the communication hardware 224 to generate an area profile for the designated area during a communication session with a communication application. As described herein, the area profile includes data collected from the area including from the communication hardware 224 associated with the area device 202 and communication hardware 222-1, 222-2, 222-3, 222-4, 222-N (collectively referred to as communication hardware 222) from computing devices 212-1, 212-2, 212-3, 212-4, 212-N (collectively referred to as computing devices 212) positioned within the designated area.

In some examples, the designated area includes a plurality of computing devices 212 that are mobile computing devices that can be easily moved into the designated area and outside the designated area by corresponding users. In this way, the area device 202 can monitor computing devices 212 entering and exiting the designated area. In some examples, the area device 202 sends a message to the computing devices 212 to invite the computing devices 212 to be part of the area profile for the designated area. The computing devices 212 can then provide audio data and/or video data from corresponding communication hardware 222 to the area device 202 during the communication session.

In some examples, the communication hardware 222 includes microphones, speakers, cameras, or other devices that can be utilized to collect data for communicating with remote devices. As described herein, the communication hardware can be controlled by the area device 202. In some examples, the area device 202 can utilized the plurality of microphones of the computing devices 212 within the area at a particular time as a microphone array and utilize the plurality of speakers of the computing devices 212 as an array of speakers for the area.

As described herein, the area device 202 utilizes the audio data and/or video data to generate a single area profile (e.g., single user profile, etc.) for the computing devices 212 and/or users of the computing devices 212 during the communication session. Since the area device 202 is collecting data from computing devices 212 within the designated area, the area device 202 is able to dynamically add and remove computing devices 212 from the area profile during the communication session. For example, computing device 212-1 can be removed from the area profile when the computing device 212 leaves the designated area. In this way, the area device 202 stops collecting audio data and video data from the computing device 212-1 in response to the computing device 212-1 leaving the designated area. In another example, an additional computing device can enter the designated area during the communication session and the area device 202 can provide the invitation message to the additional computing device to add the additional computing device to the area profile.

In some examples, the computing device 212-4 is a device for capturing data associated with a display 226 within the designated area. For example, the computing device 212-4 can be a device to capture images associated with a white board, black board, or other device to draft images (e.g., digital screen, etc.). In this example, the computing device 212-4 captures video data of the display 226 during the communication session and combines the video data of the display 226 with the video data from the computing devices 212-1, 212-2, 212-3, 212-N. In some examples, the computing device 212-4 is a stationary computing device that can be affixed to the area or not easily removed from the area. For example, the computing device 212-4 may be designated to the area to capture images of the display 226.

As described herein, the data collected from the computing devices 212 is combined into a single area profile that is presented to the communication application through a virtual audio input and/or virtual video input by the area device 202. In some examples, the other users of the communication session will view the audio data and video data from the area device 202 as if the computing devices 212 were a single user logged on to the communication session.

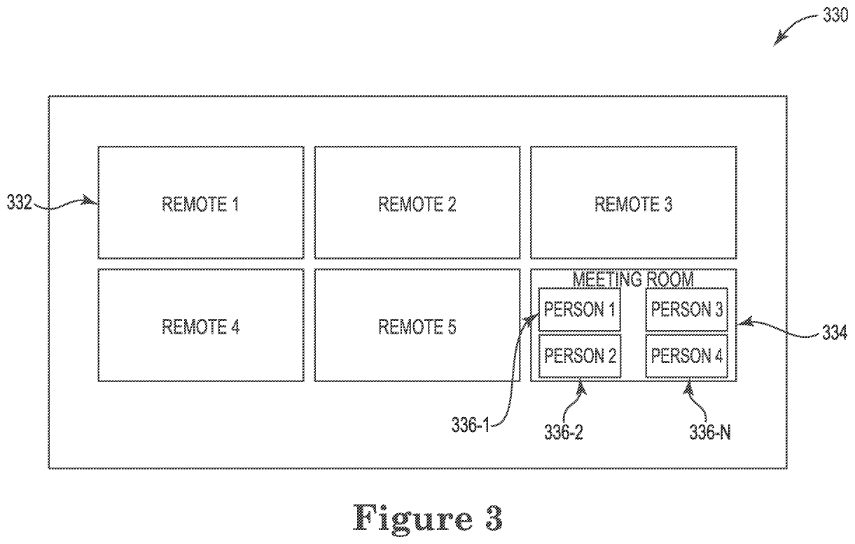

FIG. 3 illustrates an example of a display 330 for area profiles for devices. As described herein, the area profiles generated from a plurality of computing devices within an area can be utilized for a communication application such as a teleconferencing or videoconferencing application. In some examples, the display 330 is an image of what would be displayed on a user's display device (e.g., screen, monitor, etc.) during the communication session.

In some examples, each box represents a corresponding user profile. For example, a first user profile 332 can correspond to a first remote device. In these examples, the first user profile 332 can include visual data associated with the first remote device. For example, the first user profile 332 can include video data and/or image data provided to the communication application during the communication session. In this example, video data captured by hardware associated with the first remote device can be displayed within the first user profile 332 portion of the display 330.

In some examples, the area profile 334 is viewed as a single profile with video data and/or image data associated with a plurality of users 336-1, 336-2, 336-N (collectively referred to as users 336). In some examples, each of the users 336 is viewed individually within the area profile 334 as illustrated within the area profile 334. However, in other examples, the users 336 are viewed as a single image that is stitched together. In this way, a greater portion of the area and relative location of the users 336 within the area is visualized within the area profile 334. For example, the stitched image can indicate that user 336-1 is sitting next to user 336-2.

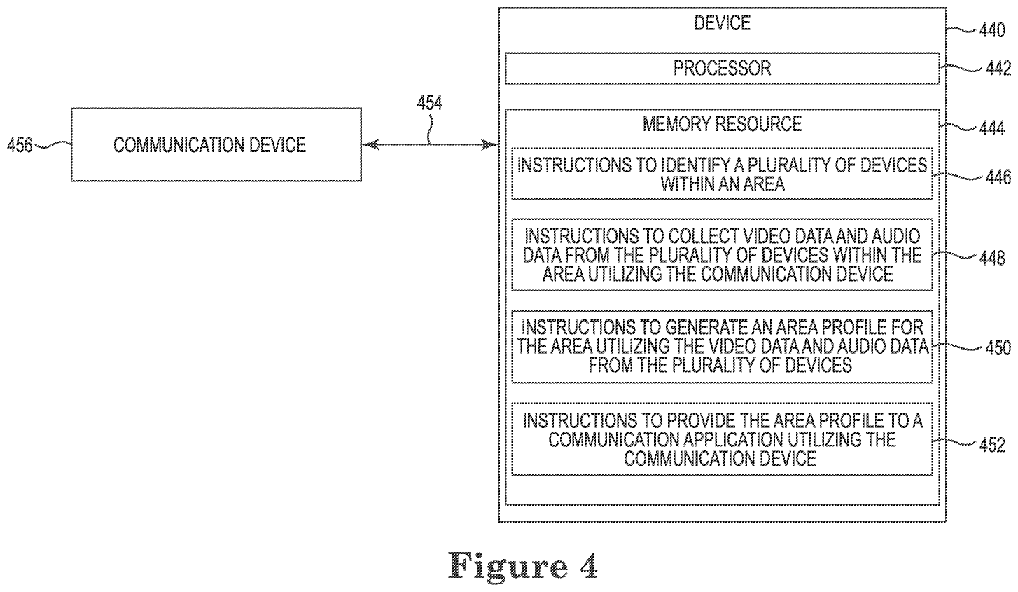

FIG. 4 illustrates an example of a device 440 for area profiles for devices. In some examples, the device 440 is a computing device that includes a processor 442 and a memory resource 444 to store instructions that are executed by the processor 442. In some examples, the device 440 includes a processor 442 and a memory resource 444 storing instructions 446, 448, 450, 452, that can be executed by the processor 442 to perform particular functions. In some examples, the device 440 is communicatively coupled to a communication device 456 and/or transmitter device through a communication path 454. In some examples, the communication path 454 allows the device 440 to send and receive signals (e.g., communication signals, electrical signals, etc.) with the communication device 456 and/or the transmitter device. In some examples, the device 460 is able to execute the methods described herein.

The device 440 includes instructions 446 stored by the memory resource 444 that is executed by the processor 442 to identify a plurality of devices within an area. In some examples, the area is a defined area or limited area. As described herein, the area can be defined by the walls of a particular room such as a conference room or office within a building. In this way, the plurality of devices is positioned within the room or area and devices that are not positioned within the room or area are restricted. Identifying the plurality of devices can include identifying a wireless signal utilizing the communication device 456.

In some examples, the communication device 456 is utilized to determine when devices are within the area and when devices are outside the area. For example, a signal strength between the communication device 456 can be utilized to determine a distance between the communication device 456 and a particular device. The particular device can be identified as being within the area when the distance is below a particular threshold distance. In other examples, the communication device 456 is an ultrasonic communication device that is limited to transmitting within the walls of a particular room. That is, the communication device 456 may not be able to communicate with devices outside the walls of a particular designated area. For example, the communication device can be an ultrasonic communication device that utilizes a signal limited by barriers (e.g., walls, glass walls, etc.) of the area.

The device 440 includes instructions 448 stored by the memory resource 444 that is executed by the processor 442 to collect video data and audio data from the plurality of devices within the area utilizing the communication device 456. In some examples, the video data and audio data are collected from hardware associated with the plurality of devices within the area during a communication session.

In these examples, the plurality of devices may be mobile devices with corresponding end users. In this way, the plurality of devices may provide the video data and audio data to the device 440 through the communication device 456. In these examples, the device 440 collects the video data and audio data from the plurality of devices during the communication session to modify the video data and audio data before providing the modified data to a communication application. In some examples, the device 440 includes instructions to restrict the communication device 456 from collecting video and audio from devices outside the area. As described herein, devices outside the walls of a particular room may be restricted by the frequencies utilized by the communication device 456. In other examples, the distance between the communication device 456 and the devices can be utilized to restrict devices outside a defined area.

The device 440 includes instructions 450 stored by the memory resource 444 that is executed by the processor 442 to generate an area profile for the area utilizing the video data and audio data from the plurality of devices. As described herein, the area profile is a user profile for a communication application that is normally designated to a single user or single device. In these examples, the area profile includes in the combined video data and combined audio data from the plurality of devices that are located within the area.

In some examples, the combined audio data can be audio data collected from microphones associated with the plurality of devices by utilizing the microphones as an array of microphones within the area. Utilizing the plurality of microphones as an array of microphones eliminates surround sounds or echoes that can be created when using a single microphone at a time to collect audio within the area. In these examples, multiple users can speak simultaneously or can alternately speak without creating an echo or poor sound quality.

In some examples, the combined video data can be a plurality of video images or still images simultaneously provided within an area associated single user. In other examples, the combined video data can include a single image from a single computing device from the plurality of devices based on a determination of a particular device being utilized. For example, the device 440 can identify a user speaking or identify that a user is writing on a display. In these examples, the identified user or identified device can be utilized or displaying the area profile video or image. In other examples, the combined video data or image data is stitched together based on a physical location within the area of the plurality of devices.

In these examples, the device 440 determines the physical location of the plurality of devices within the area and stitches the video data to create a single image displayed as the user profile video and/or user profile image. In these examples, the combined video data may represent a panoramic or 360-degree image of the area. As described herein, the panoramic or 360-degree image can provide a better representation of the location of the plurality of users of the plurality of devices compared to individual images of the users.

The device 440 includes instructions 452 stored by the memory resource 444 that is executed by the processor 442 to provide the area profile to a communication application utilizing the communication device 456. As described herein, the area profile is a single user profile utilized in a communication session for the designated area. In some examples, the communication application has a designated area or portion of a display designated for a particular user. In these examples, the area profile can be positioned within the designated area or portion for a single user.

In some examples, the device 440 can combine the video data and/or audio data can be combined as described herein and provided to the communication application through a virtual video driver and/or a virtual audio driver. In this way, the combined video data is provided to the communication application through the virtual video driver such that the communication application is receiving the combined video data through a single driver. In a similar way, the combined audio data is provided to the communication through a virtual audio driver to make it seem as though the communication application is receiving the combined audio data from a single driver.

As described herein, the device 440 includes a processor 442 communicatively coupled to a memory resource 444 through a communication path. As used herein, the processor 442 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 446, 448, 450, 452. In other examples, the device 440 includes instructions 446, 448, 450, 452, stored on a machine-readable medium (e.g., memory resource 444, non-transitory computer-readable medium, etc.) and executable by a processor 442. In a specific example, the processor 442 utilizes a non-transitory computer-readable medium storing instructions 446, 448, 450, 452, that, when executed, cause the processor 442 to perform corresponding functions.

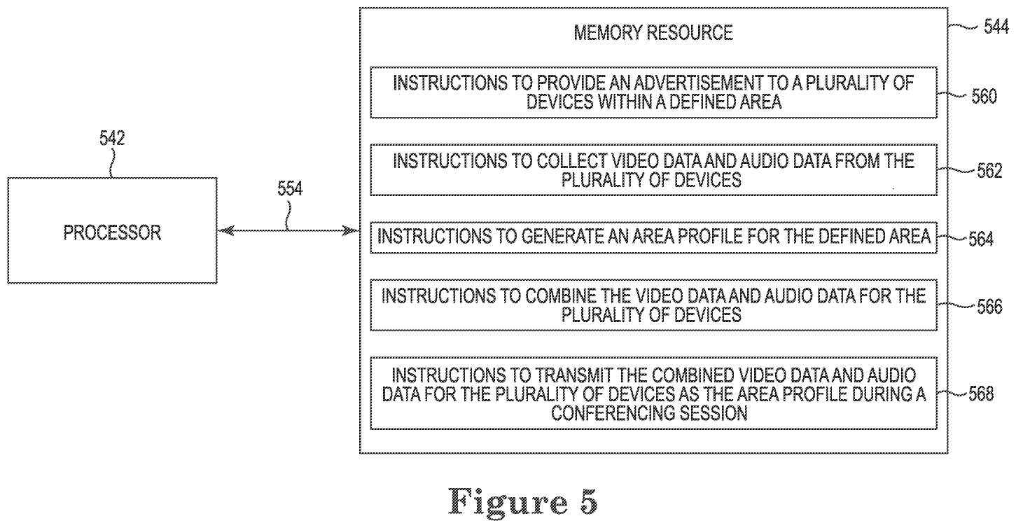

FIG. 5 illustrates an example of a memory resource 544 for area profiles for devices. In some examples, the memory resource 544 can be a part of a computing device or controller that can be communicatively coupled to a computing system. For example, the memory resource 544 can be part of a device 440 as referenced in FIG. 4. In some examples, the memory resource 544 can be communicatively coupled to a processor 542 that can execute instructions 560, 562, 564, 566, 568, stored on the memory resource 544. For example, the memory resource 544 can be communicatively coupled to the processor 542 through a communication path 554. In some examples, a communication path 554 can include a wired or wireless connection that can allow communication between devices and/or components within a single device.

The memory resource 544 may be electronic, magnetic, optical, or other physical storage device that stores executable instructions. Thus, a non-transitory machine-readable medium (MRM) (e.g., a memory resource 544) may be, for example, a non-transitory MRM comprising Random-Access Memory (RAM), read-only memory (ROM), an Electrically Erasable Programmable ROM (EEPROM), a storage drive, an optical disc, and the like. The non-transitory machine-readable medium (e.g., a memory resource 544) may be disposed within a controller and/or computing device. In this example, the executable instructions 560, 562, 564, 566, 568, can be “installed” on the device. Additionally, and/or alternatively, the non-transitory machine-readable medium (e.g., a memory resource) can be a portable, external, or remote storage medium, for example, which allows a computing system to download the instructions 560, 562, 564, 566, 568 from the portable/external/remote storage medium. In this situation, the executable instructions may be part of an “installation package”.

In some examples, the memory resource 544 includes instructions 560 to provide an advertisement to a plurality of devices within a defined area. As used herein the advertisement is an invitation or invitation message that sent to the plurality of devices that are within the defined area. In some examples, the plurality of devices receives the advertisement when the device enters the defined area. As described herein, the defined area can be defined by physical walls of a particular room of a building.

In some examples, the advertisement includes a selection to provide audio data and/or video data to an area device for the defined area. In this way, the plurality of devices are able to provide output video data and output audio data to the area device. In some examples, the advertisement includes a client application or download for a client application that the plurality of devices can utilize to provide the output audio data and/or the output video data to the are device.

In some examples, the memory resource 544 includes instructions 562 to collect video data and audio data from the plurality of devices. In some examples, the memory resource 544 can include instructions for a server application that can correspond to the client application that is utilized by the plurality of devices. In this way, the server application can receive the video output data and/or audio output data from the plurality of devices. In some examples, the video data and/or audio data is collected along with a corresponding location of the plurality of devices within the defined area. For example, the location of the plurality of devices may be determined based on a signal strength between the plurality of devices and a communication device (e.g., wireless transmitter, etc.). In this example, the location information can be associated with a device name or username associated with the plurality of devices and identified when receiving the video data and/or audio data.

In some examples, the memory resource 544 includes instructions 564 to generate an area profile for the defined area. As described herein, the area profile for the define area can include combined audio data from the plurality of devices and combined video data from the plurality of devices. In these examples, the combined audio data and combined video data can be provided through virtual drivers to mimic a single device providing audio data and video data to a communication application.

In some examples, the memory resource 544 includes instructions 566 to combine the video data and audio data for the plurality of devices. As described herein, the video data can be combined to generate a single video feed for the communication application. In addition, the audio data can be combined into a single audio file for the area profile to be utilized for the communication application.

In some examples, the memory resource 544 includes instructions 568 to transmit the combined video data and audio data for the plurality of devices as the area profile during a conferencing session. As described herein, the combined video data can be transmitted by a virtual video driver and the combined audio data can be transmitted by a virtual audio driver. In these examples, the conferencing application can receive the combined video data and combined audio data as if the data was transmitted from a single user or single profile.

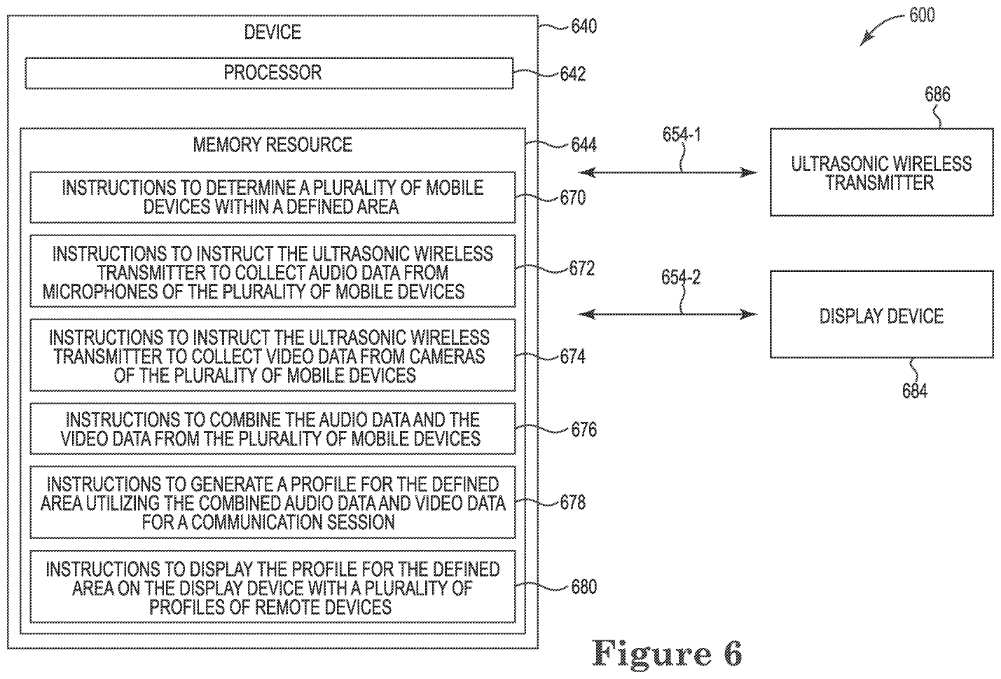

FIG. 6 illustrates an example of a system 600 for area profiles for devices. In some examples, the system 600 includes a device 640 that includes a processor 642 communicatively coupled to a memory resource 644. In some examples, the device 640 can include a computing device that includes a processor 642 and a memory resource 644 storing instructions 670, 672, 674, 676, 678, 680, that are executed by the processor 642 to perform particular functions.

In some examples, the system 600 includes an ultrasonic wireless transmitter 686 communicatively coupled to the device 640 through a communication path 654-1. In some examples, the ultrasonic wireless transmitter 686 sends and receives audio data and/or video data to the device 640. In some examples, the system 600 includes a display device 684 communicatively coupled to the device 640 through a communication path 654-2.

The device 640 includes instructions 670 stored by the memory resource 644 that can be executed by the processor 642 to determine a plurality of mobile devices within a defined area. As described herein, the plurality of mobile devices can be computing devices that are intended to be transportable from a first location to a second location by a user. In some examples, the plurality of mobile devices are laptop computers, smartphones, tablet, and/or other types of mobile devices that can be utilized for videoconferences or teleconferences.

In some examples, the plurality of mobile devices is identified when the plurality of mobile devices respond to an advertisement from the device 640 upon entering the defined area. As described herein, the defined area can include a walled room within a building where the walls restrict the area that the ultrasonic wireless transmitter 686 is capable of transmitting. In this way, only devices within the walls of the defined area are capable of communicating with the device 640 through the ultrasonic wireless transmitter 686. In this way, the plurality of mobile devices are able to receive the advertisement message from the ultrasonic wireless transmitter 686 when the plurality of mobile devices are within the defined area.

The device 640 includes instructions 672 stored by the memory resource 644 that can be executed by the processor 642 to instruct the ultrasonic wireless transmitter 686 to collect audio data from microphones of the plurality of mobile devices. As described herein, the plurality of mobile devices can include corresponding hardware, such as microphones, to collect audio data during the conferencing session. In these examples, the plurality of microphones from the plurality of mobile devices can be utilized as an array of microphones based on the physical location of the plurality of mobile devices within the defined area.

As described herein, the plurality of mobile devices can provide the audio data to the ultrasonic wireless transmitter 686 utilizing a client application provided by the device 640 through the ultrasonic wireless transmitter 686. In some examples, the device 640 receives the audio data from the plurality of mobile devices utilizing a server application that corresponds to the client applications of the plurality of mobile devices. In this way, the device 640 is able to provide the client application to mobile devices that enter the defined area and receive the audio data from the new mobile devices that enter the defined area.

The device 640 includes instructions 674 stored by the memory resource 644 that can be executed by the processor 642 to instruct the ultrasonic wireless transmitter to collect video data from cameras of the plurality of mobile devices. In some examples, the video data is collected in a similar way as the audio data from the plurality of mobile devices. For example, the hardware associated with the mobile devices, such as a video camera, can provide the output video data to the ultrasonic wireless transmitter 686 utilizing a client application provided by the device 640 through the ultrasonic wireless transmitter 686. In a similar way, the device 640 can utilize a server application that corresponds to the client application provided to the plurality of mobile devices to receive the video data through the ultrasonic wireless transmitter 686.

The device 640 includes instructions 676 stored by the memory resource 644 that can be executed by the processor 642 to combine the audio data and the video data from the plurality of mobile devices. As described herein, the audio data can be combined to a single audio file or single audio output for the defined area. In addition, the video data can be combined into a single video or single video output for the defined area.

The device 640 includes instructions 678 stored by the memory resource 644 that can be executed by the processor 642 to generate a profile for the defined area utilizing the combined audio data and video data for a communication session. In some examples, the profile for the defined area can include the same or similar features as a user profile for a conferencing application. In this way, the profile for the define area includes the same or similar outputs and data as a single user profile for the particular conferencing application.

The device 640 includes instructions 680 stored by the memory resource 644 that can be executed by the processor 642 to display the profile for the defined area on the display device 684 with a plurality of profiles of remote devices. In some examples, the conferencing session is displayed on the display device 684 such that profiles for remote devices are displayed along with the area profile for the defined area. In some examples, the display device is a video display such as a television, monitor, screen, or other type of audio/visual device. In this way, the plurality of mobile devices are able to utilize the area profile for the defined area to communicate with a plurality of remote devices through a conferencing application.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A device, comprising:
a communication device; and
a processor to:
identify a plurality of devices within an area;
collect video data and audio data from the plurality of devices within the area utilizing the communication device;
generate an area profile for the area utilizing the video data and audio data from the plurality of devices; and
provide the area profile to a communication application utilizing the communication device.

2. The device of claim 1, wherein the processor is to restrict the communication device from collecting video and audio from devices outside the area.

3. The device of claim 1, wherein the communication device is an ultrasonic communication device that utilizes a signal limited by barriers of the area.

4. The device of claim 1, wherein the area profile includes audio and video from each of the plurality of devices to be displayed within a single profile of the communication application.

5. The device of claim 1, wherein the processor is to generate a single image of the area utilizing the video data from the plurality of devices within the area.

6. A non-transitory memory resource storing machine-readable instructions stored thereon that, when executed, cause a processor of a computing device to:
provide an advertisement to a plurality of devices within a defined area;
collect video data and audio data from the plurality of devices;
generate an area profile for the defined area;
combine the video data and audio data for the plurality of devices; and
transmit the combined video data and audio data for the plurality of devices as the area profile during a conferencing session.

7. The memory resource of claim 6, wherein the processor is to determine when one of the plurality of devices leaves the defined area.

8. The memory resource of claim 7, wherein the processor is to stop collecting video data and audio data from the one of the plurality of devices that leaves the defined area.

9. The memory resource of claim 6, wherein the processor is to:
determine when an additional device enters the defined area;
send an advertisement to the additional device;
collect video data and audio data from the additional device; and
combine the video data and the audio data from the additional device to the area profile for the defined area.

10. The memory resource of claim 6, wherein the processor is to determine a location within the defined area of the plurality of devices and combine the video data from the plurality of devices to generate a video image of the defined area.

11. The memory resource of claim 6, wherein the advertisement provides access to a camera and a microphone of the plurality of devices to collect the video data and the audio data from the plurality of devices.

12. A system, comprising:
an ultrasonic wireless transmitter;
a display device; and
a processor to:
determine a plurality of mobile devices within a defined area;
instruct the ultrasonic wireless transmitter to collect audio data from microphones of the plurality of mobile devices;
instruct the ultrasonic wireless transmitter to collect video data from cameras of the plurality of mobile devices;
combine the audio data and the video data from the plurality of mobile devices;
generate a profile for the defined area utilizing the combined audio data and video data for a communication session; and
display the profile for the defined area on the display device with a plurality of profiles of remote devices.

13. The system of claim 12, wherein the processor is to determine a physical location of the plurality of mobile devices within the defined area.

14. The system of claim 13, wherein the processor is to combine the audio data and video data based on the determined physical location of the plurality of mobile devices.

15. The system of claim 12, wherein the processor is to send a request to the plurality of mobile devices when the plurality of mobile devices are within the defined area, wherein the request includes an advertisement to log on to the profile for the defined area.
